(19) United States
(12) Patent Application Publication
(10) Pub. No.: US 2026/0301127 A1
(43) Pub. Date: Oct. 1, 2026

(54) VIDEO QUALITY ENHANCEMENT METHOD, MODEL TRAINING METHOD, AND DEVICE

(71) Applicant: BOE Technology Group Co., Ltd., Beijing (CN)

(72) Inventor: Xuan SUN, Beijing (CN)

(21) Appl. No.: 18/992,840

(22) PCT Filed: Jun. 25, 2023
(86) PCT No.: PCT/CN2023/102189

§ 371 Date: Jan. 9, 2025

(30) Foreign Application Priority Data
Jan. 12, 2023 (CN) 202310041989.X

(51) Int. Cl. G06T 5/60; G06N 3/0464; G06N 3/08

(52) U.S. Cl. CPC G06T 5/60; G06N 3/0464; G06N 3/08; G06T 2207/10016; G06T 2207/20081; G06T 2207/20084

(57) ABSTRACT

The present disclosure discloses a video quality enhancement method, a model training method and devices. The method includes: obtaining a target video frame to be processed; and inputting the target video frame into an enhancement model for performing quality enhancement, and outputting an enhanced video frame corresponding to the target video frame, wherein the enhancement model is obtained by training a plurality of video frame pairs, each video frame pair includes a blended video frame and a tagged video frame, and the blended video frames and the tagged video frames contain the same video contents with different video qualities; and each blended video frame is obtained by blending a first video frame and a second video frame, the first video frames and the second video frames contain the same video contents with different video qualities.

### CROSS-REFERENCE TO RELATED APPLICATIONS

The present disclosure is a National Stage of International Application No. PCT/CN2023/102189, filed on Jun. 25, 2023, which claims priority to the Chinese patent application No. 202310041989.X filed on Jan. 12, 2023 to China National Intellectual Property Administration, the entire content of which are incorporated herein by reference.

### TECHNICAL FIELD

The present disclosure relates to the technical field of video processing, in particular to a video quality enhancement method, a model training method, and devices.

### BACKGROUND

With the booming development of the manufacturing industry of display devices, ultra high definition display terminals such as 4K and 8K, etc., have entered thousands of households. With the diversification and high standardization of video user requirements, especially the urgent requirement for ultra high definition video resources, video-oriented quality enhancement technologies have gradually become a research hotspot.

In recent years, researches on video quality enhancement algorithms based on deep learning have made unprecedented progresses. However, due to the difficulty of video enhancement tasks, in order to ensure the enhancement effect, video enhancement models are generally designed to be relatively large and complex, which brings great difficulties to model training and actual deployment.

### SUMMARY

The present disclosure provides a video quality enhancement method, a model training method and devices, used for improving the recovery ability for low-quality videos with the lower training cost.

In a first aspect, an embodiment of the present disclosure provides a video quality enhancement method, including: obtaining a target video frame to be processed; and inputting the target video frame into an enhancement model for performing quality enhancement, and outputting an enhanced video frame corresponding to the target video frame, wherein the enhancement model is obtained by training a plurality of video frame pairs, each video frame pair includes a blended video frame and a tagged video frame, and the blended video frame and the tagged video frame contain the same video contents with different video qualities; and each blended video frame is obtained by blending a first video frame and a second video frame, and the first video frame and the second video frame contain the same video contents with different video qualities.

In a second aspect, an embodiment of the present disclosure provides a model training method, including: obtaining a blended video frame by blending a first video frame and a second video frame, wherein the first video frame and the second video frame contain the same video contents with different video qualities; determining a video frame pair according to the blended video frame and a tagged video frame corresponding to the blended video frame, wherein the blended video frame and the tagged video frame contain the same video contents with different video qualities; and obtaining an enhancement model by training a to-be-trained enhancement model by utilizing a plurality of video frame pairs.

In a third aspect, an embodiment of the present disclosure further provides a display device, including a display and a processor, wherein: the display is configured to display contents; and the processor is configured to execute steps of the method in the first aspect above.

In a fourth aspect, an embodiment of the present disclosure further provides an electronic device, including a processor and a memory, wherein the memory is configured to store a program executable by the processor, and the processor is configured to read the program in the memory and execute steps of the method in the first aspect or the second aspect above.

In a fifth aspect, an embodiment of the present disclosure further provides a computer storage medium, storing a computer program thereon, wherein a processor, when the computer program executed by the processor, is used for implementing steps of the method in the first aspect or the second aspect above.

These or other aspects of the present disclosure will be clearer and more easily understood in the description of the following embodiments.

### BRIEF DESCRIPTION OF FIGURES

In order to explain technical solutions in embodiments of the present disclosure more clearly, the following will briefly introduce the accompanying drawings that need to be used in the description of the embodiments. Apparently, the accompanying drawings in the following description are only some embodiments of the present disclosure, and for those of ordinary skill in the art, on the premise of no creative labor, other accompanying drawings can further be obtained from these accompanying drawings.

FIG. 1A is an implementation flowchart of a video quality enhancement method provided by an embodiment of the present disclosure.

FIG. 1B is a schematic diagram of fuzzy processing provided by an embodiment of the present disclosure.

FIG. 2 is a schematic diagram of obtaining a blended video frame by splicing provided by an embodiment of the present disclosure.

FIG. 3 is a schematic diagram of a blended video frame provided by an embodiment of the present disclosure.

FIG. 4 is a schematic diagram of a plurality of blended video frames provided by an embodiment of the present disclosure.

FIG. 5 is a schematic diagram of effect comparison of different blending ratios provided by an embodiment of the present disclosure.

FIG. 6 is a schematic diagram of effect comparison of blending of different image block sizes provided by an embodiment of the present disclosure.

FIG. 7 is a schematic diagram of model effect comparison provided by an embodiment of the present disclosure.

FIG. 8 is a schematic structural diagram of an enhancement model provided by an embodiment of the present disclosure.

FIG. 9 is an implementation flowchart of a model training method provided by an embodiment of the present disclosure.

FIG. 10 is a schematic diagram of a display device provided by an embodiment of the present disclosure.

FIG. 11 is a schematic diagram of an electronic device provided by an embodiment of the present disclosure.

FIG. 12 is a schematic diagram of another electronic device provided by an embodiment of the present disclosure.

FIG. 13 is a schematic diagram of a video enhancement apparatus provided by an embodiment of the present disclosure.

FIG. 14 is a schematic diagram of a model training apparatus provided by an embodiment of the present disclosure.

### DETAILED DESCRIPTION

In order to make the objects, technical solutions and advantages of the present disclosure clearer, the present disclosure will be further described in detail in combination with the accompanying drawings below. Apparently, the described embodiments are only part of the embodiments of the present disclosure, not all of them. Based on the embodiments of the present disclosure, all other embodiments obtained by those of ordinary skill in the art without creative work shall fall within the protection scope of the present disclosure.

In the embodiments of the present disclosure, the term “and/or” describes the association relationship of associated objects, which represents that there can be three kinds of relationships, for example, A and/or B can represent three kinds of situations: A alone, A and B at the same time, and B alone. The character “/” universally represents that front and back associated objects are in an “or” relationship.

Application scenarios described in the embodiments of the present disclosure are to more clearly illustrate the technical solutions of the embodiments of the present disclosure, and do not constitute a limitation on the technical solutions provided by the embodiments of the present disclosure. It is known to those ordinarily skilled in the art that with the appearance of new application scenarios, the technical solutions provided by the embodiments of the present disclosure are also suitable for similar technical problems. In the description of the present disclosure, unless otherwise stated, “plurality of” means two or more.

With the diversification and high standardization of video user requirements, especially the urgent requirement for ultra high definition video resources, an efficient video encoding and decoding technology is facing great challenges. Decoded compressed videos generally have obvious compression artifacts, which seriously affect the subjective effect of the videos. In addition, with the booming development of the manufacturing industry of display devices, ultra high definition display terminals such as 4K and 8K, etc., have entered thousands of households. The artifacts and distortions in compressed videos will be further magnified on ultra high definition display devices. Therefore, compressed video-oriented quality enhancement technologies have become a research hotspot in the industry. In recent years, researches on video quality enhancement algorithms based on deep learning have made unprecedented progresses. However, due to the difficulty of video enhancement tasks, in order to ensure the enhancement effect, video enhancement models are generally designed to be relatively large and complex, which brings great difficulties to model training and actual deployment. The essence of a knowledge distillation strategy used in video and image enhancement tasks is to transfer the abilities of teacher models to student models, or to enable models to learn a pixel layout in an original video through certain design. Therefore, existing methods often design large teacher models to guide student models for learning, or design complex distillation loss functions, and the fact that only the student models are used for inference highlights the inefficiency of the teacher models and multiple loss calculations during training.

In response to the problems that the effect of an existing compressed video enhancement model is difficult to be improved and there is no specific knowledge distillation strategy for compressed video enhancement, an embodiment provides a video enhancement method which can learn arrangement rules of pixels in original video frames, without the need for additionally designing teacher models and distillation loss functions, and with almost no increase in training cost, it significantly enhances the recovery ability to compressed video frames.

The core idea of the video enhancement method provided by the present embodiment is that, a first video frame and a second video frame having the same video contents with different video qualities are blended to obtain a blended video frame, a to-be-trained enhancement model is trained by using the blended video frame and a tagged video frame corresponding to the blended video frame as a video frame pair, and by learning information in a video frame with the relatively high video quality, the information is distilled into model parameters of the enhancement model so as to guide the enhancement model to learn a supplementing relationship between adjacent pixel points on a spatial dimension within the frame, and a complementary relationship between pixel points corresponding to different video frames on a temporal dimension between frames; and in a training process, there is no need to design a large teacher model to guide a student model for learning, or to design a complex distillation loss function, so that it significantly enhances the enhancement model's recovery ability to video frames with poor video quality (such as compressed frames) almost without increasing training costs.

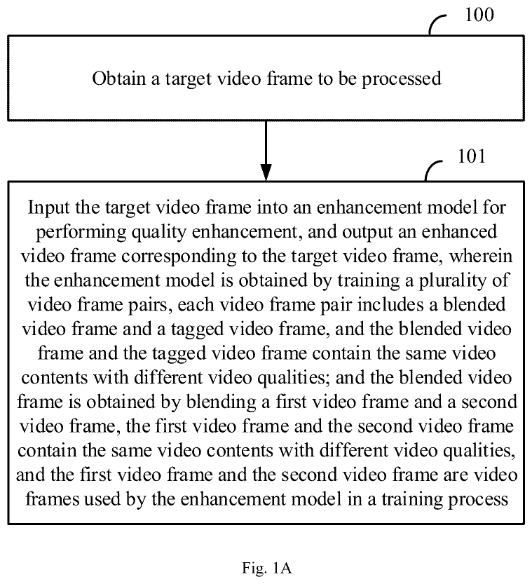

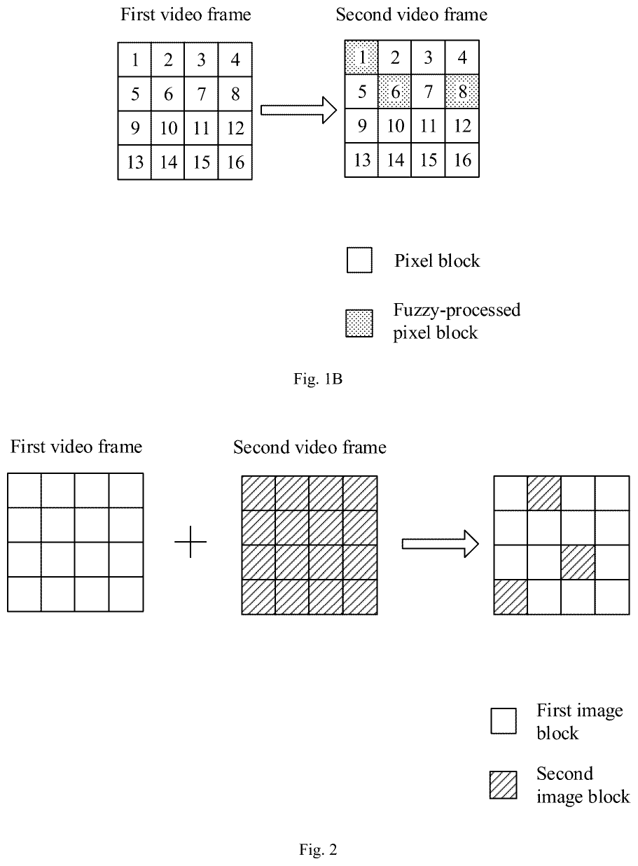

As shown in FIG. 1A, an implementation flow of a video quality enhancement method provided by an embodiment is as follows.

Step 100, a target video frame(s) to be processed is obtained.

During implementation, the target video frame(s) may be a video frame(s) to be processed, and the quality of the video frame is improved by processing it through an enhancement model, for example, the target video frame may be a video frame which is relatively low in video quality or fuzzy, such as a decoded compressed video frame, which is not limited too much in the present embodiment.

Step 101, the target video frame is input into the enhancement model for performing quality enhancement, and an enhanced video frame corresponding to the target video frame is output, wherein the enhancement model is obtained by training a plurality of video frame pairs, each video frame pair includes a blended video frame and a tagged video frame, and the blended video frame and the tagged video frame contain the same video contents with different video qualities; and each blended video frame is obtained by blending a first video frame and a second video frame, the first video frame and the second video frame contain the same video contents with different video qualities, and the first video frame and the second video frame are video frames used by the enhancement model in a training process.

During implementation, the enhanced video frame in the present embodiment is a video frame with the video quality better than that of the target video frame, or a video frame clearer than the target video frame, and the function of the enhancement model is to perform video quality enhancement processing on the target video frame so as to improve the video quality or definition of the target video frame.

Optionally, the assessment on the video quality includes but is not limited to subjective assessment and objective assessment. The subjective assessment is used for organizing laboratory technicians to judge the video quality via human eyes, wherein different types of laboratory technicians are organized as far as possible to give randomness and diversity to experiments so as to make the subjective assessment more generalized and convincible. The objective assessment is to calculate a difference between two videos to be compared through a standard mathematical formula(s), assessment standards include but are not limited to peak signal to noise ratio (PSNR), mean square error (MES), a human visual system (HVS), etc., and the selection of a specific assessment standard may be determined according to actual needs, which is not limited too much in the present embodiment.

Optionally, a network structure of the enhancement model in the present embodiment includes a deep learning model, and the network structure of the enhancement model is not limited too much in the present embodiment.

In some embodiments, the second video frame is obtained by performing fuzzy processing on the first video frame, and the video quality of the second video frame is lower than the video quality of the first video frame; or the first video frame is obtained by performing fuzzy processing on the second video frame, and the video quality of the first video frame is lower than the video quality of the second video frame. In this case, the first video frame and the second video frame are completely different in video quality.

Optionally, the second video frame is obtained by performing fuzzy processing on part of pixel blocks in the first video frame, and at the moment, only part of pixel blocks in the first video frame and the second video frame are different in video quality, while other pixel blocks are the same in video quality. During implementation, the first video frame is split into a plurality of pixel blocks, and after performing fuzzy processing on part of pixel blocks therein, the second video frame is obtained after merging the fuzzy-processed pixel blocks and pixel blocks not subjected to fuzzy processing in the first video frame. As shown in FIG. 1B, the present embodiment provides a schematic diagram of fuzzy processing. A first video frame is split into 16 pixel blocks, and after performing fuzzy processing on the 1^{st}, 6^{th} and 8^{th} pixel blocks, a second video frame is obtained after splicing the fuzzy-processed 1^{st}, 6^{th} and 8^{th} pixel blocks and remaining pixel blocks not subjected to fuzzy processing according to corresponding pixel positions. The 1^{st}, 6^{th} and 8^{th} pixel blocks in the first video frame and 1^{st}, 6^{th} and 8^{th} pixel blocks in the second video frame are different in video quality, and other pixel blocks are the same in video quality.

Optionally, the first video frame is obtained by performing fuzzy processing on part of pixel blocks in the second video frame. During implementation, the second video frame is split into a plurality of pixel blocks, and after performing fuzzy processing on part of pixel blocks therein, the first video frame is obtained after merging the fuzzy-processed pixel blocks and pixel blocks not subjected to fuzzy processing in the second video frame.

It should be noted that the first video frame and the second video frame contain the same video contents with different video qualities. One implementation is that, the first video frame and the second video frame are different in entire video quality, that is, the second video frame is obtained by performing fuzzy processing on entire pixels of the first video frame, or the first video frame is obtained by performing fuzzy processing on entire pixels of the second video frame. Another implementation is that, part of contents in videos of the first video frame and the second video frame are different in video quality, that is, the second video frame is obtained by performing fuzzy processing on part of pixel blocks in the first video frame, or, the first video frame is obtained by performing fuzzy processing on part of pixel blocks in the second video frame.

Optionally, the fuzzy processing in the present embodiment includes but is not limited to compression, encoding, etc., and may also be other fuzzy processing manners used for processing video frames with relatively high video quality to video frames with relatively low video quality, which is not limited too much in the present embodiment.

In some embodiments, the plurality of video frame pairs have a time sequence on a temporal dimension.

It should be noted that, the first video frame and the second video frame in the present embodiment are video frames used by the enhancement model in the training process, and the target video frame is a video frame input into the enhancement model in a using process. In the training process for the enhancement model, training samples need to be determined, and in the present embodiment, the enhancement model is trained by using the plurality of video frame pairs as training samples, wherein, in a process of generating the training samples, original video frames (i.e., video frames directly collected by a collecting device) need to be collected, and the original video frames are processed to obtain processed video frames corresponding to the original video frames. In the present embodiment, the first video frames may be the original video frames and the second video frames may be the processed video frames; or, the second video frames are the original video frames and the first video frames are the processed video frames. Blended video frame is obtained by blending the original video frames and the corresponding processed video frames. That is, when the training samples are obtained, the original video frames need to be collected and processed, the blended video frame is obtained by blending the original video frames and the processed video frames obtained by processing, the blended video frames and corresponding tagged video frames are used as video frame pairs, and the training samples are generated finally.

Optionally, the blended video frames contained in the plurality of video frames may be regarded as being obtained after processing a plurality of first video frames or second video frames which are collected successively, and if the plurality of first video frames are collected successively through a collecting device such as a camera device, each first video frame is subjected to fuzzy processing to obtain the corresponding second video frame, and the blended video frame is obtained by blending the first video frames and the second video frames; similarly, if the plurality of second video frames are collected successively through the collecting device such as the camera device, each second video frame is subjected to fuzzy processing to obtain the corresponding first video frame, and the blended video frame is obtained by blending the first video frames and the second video frames. During specific implementation, types of the collected original video frames may be selected according to actual needs, and in the present embodiment, the first video frames may be used as the original video frames and the second video frames are used as the processed video frames obtained by processing the original video frames; or the second video frames may be used as the original video frames and the first video frames are used as the processed video frames obtained by processing the original video frames. Types of the first video frames and the second video frames in the present embodiment may be the same or different. When the first video frames and the second video frames are different in type, the first video frames or the second video frames may be determined to be collected as the original video frames according to the types of the original video frames which need to be collected. Optionally, the types of the video frames in the present embodiment are used for distinguishing objects contained in the video frames, or for distinguishing the quality of the video frames, or for distinguishing formats of the video frames, which are not limited too much in the present embodiment. The objects include but are not limited to at least one of vehicles, faces, humans, or animals, and the formats include but are not limited to at least one of RAR format, ZIP format, MPEG format, MPG format, DAT format, MP4 format, AVI format, MOV format, ASF format, WMV format, MKV format, or FLVRMVB format.

In the process of training the enhancement model in the present embodiment, training is performed by using the blended video frames as input. Since the blended video frames contain information of two types of video frames different in video quality, in the training process, the enhancement model is guided to learn a supplementing relationship between adjacent pixel points on a spatial dimension within frames, and since the plurality of video frame pairs are input in the training process and they have a time sequence on a temporal dimension, in the training process, the enhancement model may also be guided to learn a complementary relationship between pixel points corresponding to different video frames on a temporal dimension between the frames.

In some embodiments, the present embodiment determines the blended video frames through any one of the following manners.

Manner (1): part of image blocks are selected from the first video frame and the second video frame respectively, and the blended video frame is obtained by splicing the selected image blocks.

In this manner, in the present embodiment, blending on a pixel dimension is performed, and part of pixels in two video frames different in video quality are blended to obtain the blended video frame, wherein the blended video frame, the first video frame and the second video frame in the present embodiment are the same in size.

Optionally, the selected image blocks are spliced in the following way to obtain the blended video frame. Step 1a, the first video frame is split into N first image blocks, and the second video frame is split into N second image blocks, wherein N is a positive integer; step 1b, M first image blocks are selected from the N first image blocks, and N−M second image blocks are selected from the N second image blocks, wherein M is an integer greater than 0 and less than N; and step 1c, the blended video frame are obtained by splicing the M first image blocks and the N−M second image blocks.

In some embodiments, the image blocks are spliced in the following way: obtaining the blended video frame by splicing the M first image blocks and the N−M second image blocks according to positions of the first image blocks and the second image blocks in respective video frames, wherein the positions of the first image blocks and the second image blocks in respective video frames are different.

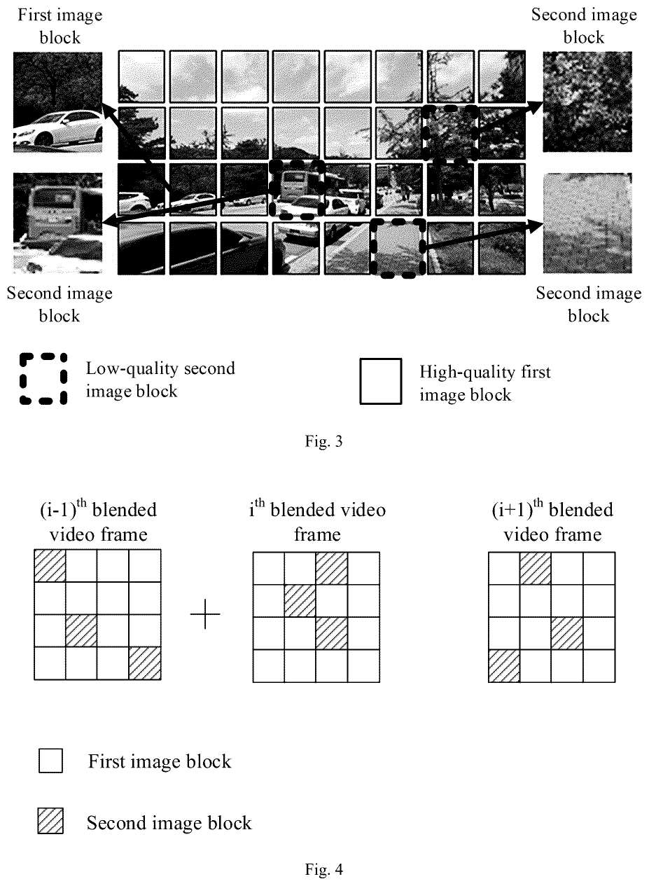

As shown in FIG. 2, the present embodiment provides a schematic diagram of a blended video frame obtained by splicing. A first video frame is a collected original video frame and is relatively high in quality and relatively clear, and a second video frame is a video frame obtained by performing compressing and encoding on the original video frame and is relatively low in quality and relatively fuzzy. The first video frame and the second video frame are each split into N image blocks (i.e., pixel blocks, and pixel matrices), M first image blocks are selected randomly, the positions of selected second image blocks in the second video frame are determined according to the positions of the selected first image blocks in the first video frame, and the selected first image blocks and second image blocks are spliced according to respective position relationships to obtain the blended video frame. As shown in FIG. 3, a schematic diagram of a blended video frame provided by the present embodiment, the blended video frame includes relatively clear first image blocks and relatively fuzzy second image blocks.

In some embodiments, a size of each split image block is determined based on an adopted encoding standard. During implementation, the size of each of the first image blocks or the second image blocks is determined according to first encoding in a case that the second video frame is obtained by performing first encoding on the first video frame; or, the size of each of the first image blocks or the second image blocks is determined according to second encoding in a case that the first video frame is obtained by performing second encoding on the second video frame.

During implementation, the size of the first image block or the second image block may be determined according to an encoding standard adopted by first encoding; or the size of the first image block or the second image block may be determined according to an encoding standard adopted by second encoding. For example, the encoding standard adopted by first encoding is 64×64, and then the size of the first image block or the second image block is also 64×64.

It should be noted that, since existing video encoding standards are all block-based encoding manners, according to an encoding manner of each video frame, the present embodiment divides the image blocks (pixel blocks) according to at least one of 64×64, 32×32, 16×16, 8×8 or 4×4. Which size of image blocks is specifically selected may further be obtained according to actual needs or tests, which is not limited too much in the present embodiment.

As an optional implementation, in the present embodiment, the blended video frame may be further obtained by calculation through the following formula:

$${X}_{i} = {M}_{r , w} ⊙ {f}_{i}^{GT} + ( 1 - {M}_{r , w} ) ⊙ {f}_{i}^{C} . \qquad Formula ( 1 )$$

In the formula, Xᵢ represents the i^{th} blended video frame, M_{r,w} represents a selection strategy of the first image block(s), namely selecting the first image block(s) at which position(s) in the first video frame,

$${f}_{i}^{G T}$$

represents the i^{th} first video frame,

$${f}_{i}^{C}$$

represents the i^{th} second video frame, r represents a ratio of the first image block(s) (original image block(s) in an original video frame) in image blocks of the blended video frame, w represents a size of each image block (i.e., the size of the first image block or the second image block), w is generally set to be an integer multiple of 2 with the setting range of 2 to 32, and ⊙ represents point multiplication.

It should be noted that, the first video frame

$${f}_{i}^{G T}$$

represents the collected original video frame, and the second video frame

$${f}_{i}^{C}$$

represents a compressed video frame obtained by compressing the original video frame.

During implementation, how to obtain the blended video frame is illustrated as follows by taking an example that r is set to be 0.5, w is set to be 2, and a dimension of

$${f}_{i}^{G T}$$

is 4×4.

It is assumed that a pixel matrix of the first video frame

$${f}_{i}^{G T}$$

is as follows:

$$[ \begin{matrix}2 & 2 & 2 & 2 \\ 2 & 2 & 2 & 2 \\ 2 & 2 & 2 & 2 \\ 2 & 2 & 2 & 2\end{matrix} ] .$$

It is assumed that a pixel matrix of the second video frame

$${f}_{i}^{C}$$

is as follows:

$$[ \begin{matrix}3 & 3 & 3 & 3 \\ 3 & 3 & 3 & 3 \\ 3 & 3 & 3 & 3 \\ 3 & 3 & 3 & 3\end{matrix} ] .$$

Wherein

$${f}_{i}^{G T}$$

is divided into four 2×2 pixel blocks (i.e., the first image blocks), and then

$${f}_{i}^{G T}$$

contains four 2×2 first image blocks in total. First image blocks with a ratio of 0.5 in the four first image blocks are selected randomly from the four first image blocks to be reserved, for example, the 1^{st} and the 4^{th} first image blocks (pixel blocks) are reserved, and values of the remaining first image blocks (pixel blocks) are set to be 0. At the moment, the selection strategy M_{r,w} of the first image blocks may be represented as:

$$[ \begin{matrix}1 & 1 & 0 & 0 \\ 1 & 1 & 0 & 0 \\ 0 & 0 & 1 & 1 \\ 0 & 0 & 1 & 1\end{matrix} ] .$$

Then a result of

$${M}_{r , w} ⊙ {f}_{i}^{GT}$$

is:

$$[ \begin{matrix}2 & 2 & 0 & 0 \\ 2 & 2 & 0 & 0 \\ 0 & 0 & 2 & 2 \\ 0 & 0 & 2 & 2\end{matrix} ] .$$

Then a result of

$$( 1 - {M}_{r , w} ) ⊙ {f}_{i}^{C}$$

is:

$$[ \begin{matrix}0 & 0 & 3 & 3 \\ 0 & 0 & 3 & 3 \\ 3 & 3 & 0 & 0 \\ 3 & 3 & 0 & 0\end{matrix} ] .$$

Then a specific pixel value of the blended video frame Xᵢ is as follows:

$$[ \begin{matrix}2 & 2 & 3 & 3 \\ 2 & 2 & 3 & 3 \\ 3 & 3 & 2 & 2 \\ 3 & 3 & 2 & 2\end{matrix} ] .$$

It should be noted that, the selection strategy M_{r,w} of the first image blocks corresponding to each blended video frame Xᵢ in the present embodiment is random, as shown in FIG. 4, the present embodiment provides a schematic diagram of a plurality of blended video frames, and an enhancement model is trained by using the plurality of successive blended video frames Xᵢ obtained in this way and a tagged video frame corresponding to each blended video frame as an input of the enhancement model and using the tagged video frame corresponding to each blended video frame Xᵢ as an output of the enhancement model.

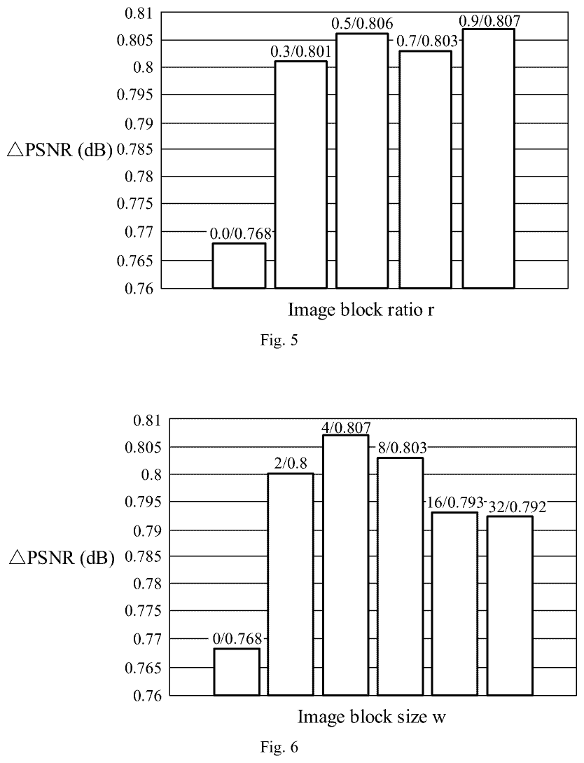

During implementation, based on the same one enhancement model, on the premise that w is 4, experiments are carried out for r of different magnitudes. It needs to be noted that, the selection of w has certain connections with a video encoding process itself. Since existing video encoding standards all are the block-based encoding manner, according to the content of each frame, the pixel blocks are divided according to the size of 64×64, 32×32, 16×16, 8×8 or 4×4. Thus, in the present disclosure, experiments are carried out on 32×32, 16×16, 8×8, 4×4 and 2×2 respectively, and as shown in FIG. 5, a schematic diagram of effect comparison of different blending ratios provided by the present embodiment, wherein abscissas represent a ratio r of the first image blocks, and ordinates represent a peak signal to noise ratio (PSNR). Results show that the enhancement model has the best effect when w=4. Thus, when the setting of r is explored, output results of the enhancement model are compared on the premise of w=4. It can be seen that the recovery ability of the enhancement model can be effectively improved by blending of any ratio. The enhancement model has the best effect when r is 0.9. The present embodiment may use truth values

$${f}_{i}^{GT}$$

of the original video frames almost completely as an input, and in order to avoid the problem that model training fails finally due to the fact that an enhancement network cannot calculate losses because the model is trained by completely using

$${f}_{i}^{GT}$$

as the input, the present embodiment may reserve

$${f}_{i}^{C}$$

with a ratio of 0.1 in Xᵢ.

As shown in FIG. 6, the present embodiment provides a schematic diagram of effect comparison of blending of different image block sizes, wherein abscissas represent an image block size w, and ordinates represent a peak signal to noise ratio (PSNR). Based on the same one enhancement model, on the premise that r is 0.9, namely on the premise that a ratio of the first image blocks (original image blocks) is 0.9, experiments are carried out for w of different magnitudes. It can be seen that the recovery ability of the enhancement model can be effectively improved by blending of image blocks of any size. The enhancement model has the best enhancement effect when w is 4. That is, when image block division is carried out on

$${f}_{i}^{GT} and {f}_{i}^{C}$$

respectively with the standard of 4×4 and the divided image blocks are blended according to a ratio of 0.9, the enhancement model has the strongest enhancement ability.

As an optional implementation, in the present embodiment, the blended video frame may be further obtained by calculation through the following formula:

$${X}_{i} = {M}_{r , w} ⊙ {f}_{i}^{GT} + ( 1 - {M}_{r , w} ) ⊙ {f}_{i}^{C} . \qquad Formula ( 2 )$$

In the formula, Xᵢ represents the i^{th} blended video frame, M_{r,w} represents a selection strategy of the second image blocks, namely selecting the second image blocks at which positions in the second video frame,

$${f}_{i}^{GT}$$

represents the i^{th} second video frame,

$${f}_{i}^{C}$$

represents the i^{th} first video frame, r represents a ratio of the second image blocks (original image blocks in an original video frame) in image blocks of the blended video frame, w represents a size of each image block (i.e., the size of the first image block or the second image block), w is generally set to be an integer multiple of 2 with the setting range of 2 to 32, and ⊙ represents point multiplication.

It should be noted that, the second video frame

$${f}_{i}^{GT}$$

represents the collected original video frame, and the first video frame

$${f}_{i}^{C}$$

represents a compressed video frame obtained by compressing the original video frame.

In the present embodiment, the first video frame includes a plurality of first image blocks, and the second video frame includes a plurality of second image blocks. The first video frame may be the original video frame, and the second video frame is the compressed video frame; or, the second video frame may be the original video frame, and the first video frame is the compressed video frame.

In the present embodiment, by performing blending of the image blocks at random positions on the input Xᵢ of each frame, the enhancement model is guided to learn the supplementing relationship between the adjacent pixel points on the spatial dimension within the frames and to learn the complementary relationship between the pixel points corresponding to different video frames on the temporal dimension between the frames.

Manner (2): part of feature vectors are selected from feature information of the first video frame and the second video frame respectively, a spliced feature vector is obtained by splicing the selected feature vectors, and the blended video frame is determined according to the spliced feature vector.

During implementation, in the present embodiment, feature information of video frames different in video quality may be further blended, and specific blending steps are as follows.

Step 2a, first feature information of the first video frame and second feature information of the second video frame are extracted.

Optionally, the feature information in the present embodiment includes but is not limited to pixel features, texture features, background features, etc., which is not limited too much in the present embodiment.

Step 2b, the first feature information is split into K first feature vectors, and the second feature information is split into K second feature vectors, wherein K is a positive integer.

Step 2c, feature information of the blended video frame is obtained by splicing P first feature vectors and K−P second feature vectors, wherein P is an integer greater than 0 and less than K.

Step 2d, the blended video frame is determined according to the feature information of the blended video frame.

In some embodiments, after the blended video frame is determined through the above manner, a tagged video frame corresponding to each blended video frame further needs to be determined to be used as one video frame pair which is input into the enhancement model to train the enhancement model. During implementation, in a specific training process, the blended video frame in each video frame pair is input into the to-be-trained enhancement model, a first loss function is determined according to an output result and the tagged video frame corresponding to the blended video frame in the video frame pair, and the enhancement model is trained according to a value of the first loss function.

In some embodiments, in the present embodiment, the tagged video frame may be determined through any one of the following manners.

Manner a), the tagged video frame corresponding to the blended video frame contained in the video frame pair is determined according to the first video frame in a case that the video quality of the second video frame is lower than the video quality of the first video frame.

During implementation, if the video quality of the second video frame is lower than that of the first video frame, it indicates that the second video frame is obtained by performing fuzzy processing on the first video frame, the first video frame represents the collected original video frame, the second video frame may be the compressed video frame obtained by compressing the original video frame, and after the blended video frame is obtained by blending the original video frame and the compressed video frame, the tagged video frame corresponding to the blended video frame is the original video frame, namely the first video frame.

When the first loss function is calculated according to the output result of the blended video frame and the tagged video frame corresponding to the blended video frame, it is only necessary to calculate an output result of compressed image blocks in the compressed video frame in the blended video frame as well as a first loss function between original image blocks in the original video frame corresponding to the compressed image blocks, that is, when the first loss function is calculated, the first loss function is calculated according to the output result of the second image blocks in the blended video frame and the first image blocks corresponding to the second image blocks. The first image blocks corresponding to the second image blocks are first image blocks located at the same positions as the second image blocks in the first video frame (i.e., the original video frame). The second image blocks are image blocks selected from the second video frame.

Manner b), the tagged video frame corresponding to the blended video frame contained in the video frame pair is determined according to the second video frame in a case that the video quality of the first video frame is lower than the video quality of the second video frame.

During implementation, if the video quality of the first video frame is lower than that of the second video frame, it indicates that the first video frame is obtained by performing fuzzy processing on the second video frame, the second video frame represents the collected original video frame, the first video frame may be the compressed video frame obtained by compressing the original video frame, and after the blended video frame is obtained by blending the original video frame and the compressed video frame, the tagged video frame corresponding to the blended video frame is the original video frame, namely the second video frame.

When the first loss function is calculated according to the output result of the blended video frame and the tagged video frame corresponding to the blended video frame, it is only necessary to calculate an output result of compressed image blocks in the compressed video frame in the blended video frame as well as a first loss function between original image blocks in the original video frame corresponding to the compressed image blocks, that is, when the first loss function is calculated, the first loss function is calculated according to the output result of the first image blocks in the blended video frame and the second image blocks corresponding to the first image blocks. The second image blocks corresponding to the first image blocks are second image blocks located at the same positions as the first image blocks in the second video frame (i.e., the original video frame). The first image blocks are image blocks selected from the first video frame.

In some embodiments, in the present embodiment the enhancement model may be determined in the following way: obtaining a first enhancement model by training the to-be-trained enhancement model by utilizing the plurality of video frame pairs; and obtaining the enhancement model by continuing to train the first enhancement model by utilizing a plurality of first video frame pairs, wherein each first video frame pair includes a third video frame and a fourth video frame, and the third video frame and the fourth video frame contain the same video contents with different video qualities.

During implementation, through two stages of a training process, the enhancement model is trained to obtain a final enhancement model, and the specific training process is as follows.

At first stage, the first enhancement model is obtained by training the to-be-trained enhancement model by utilizing the plurality of video frame pairs.

Optionally, the blended video frame is input into the to-be-trained enhancement model, and the first loss function is determined according to an output result and the tagged video frame corresponding to the blended video frame; and model parameters of the to-be-trained enhancement model are trained according to the first loss function, it is determined that the training is completed when a value of the first loss function meets a preset condition, and the first enhancement model is obtained.

The first loss function is calculated specifically through any one of the following manners.

Manner i, if the second video frame is obtained by performing fuzzy processing on the first video frame, the first video frame represents the collected original video frame, the second video frame may be the compressed video frame obtained by compressing the original video frame, the first video frame includes a plurality of first image blocks, and the second video frame includes a plurality of second image blocks, then the first loss function is calculated according to an output result of the second image blocks in the blended video frame as well as the first image blocks corresponding to the second image blocks. The first image blocks corresponding to the second image blocks are first image blocks located at the same positions as the second image blocks in the first video frame (i.e., the original video frame).

Manner ii, if the first video frame is obtained by performing fuzzy processing on the second video frame, the second video frame represents the collected original video frame, the first video frame may be the compressed video frame obtained by compressing the original video frame, the first video frame includes a plurality of first image blocks, and the second video frame includes a plurality of second image blocks, then the first loss function is calculated according to an output result of the first image blocks in the blended video frame as well as the second image blocks corresponding to the first image blocks. The second image blocks corresponding to the first image blocks are second image blocks located at the same positions as the first image blocks in the second video frame (i.e., the original video frame).

At second stage, the enhancement model is obtained by continuing to train the first enhancement model by utilizing the plurality of first video frame pairs.

In some embodiments, the first video frame pair(s) includes the third video frame(s) and the corresponding fourth video frame(s), the fourth video frame is obtained by performing fuzzy processing on the third video frame, and the video quality of the fourth video frame is lower than the video quality of the third video frame; or the third video frame is obtained by performing fuzzy processing on the fourth video frame, and the video quality of the third video frame is lower than the video quality of the fourth video frame.

During implementation, the second stage of training is carried out through any one of the following manners.

Manner A), the third video frame is input into the first enhancement model if the video quality of the third video frame contained in the first video frame pair is lower than that of the fourth video frame, and a second loss function is determined according to an output result and the fourth video frame; and model parameters of the first enhancement model are trained according to the second loss function, it is determined that training is completed when a value of the second loss function meets a preset condition or the number of iterations meets a threshold, and the trained enhancement model is obtained.

In this manner, the third video frame is obtained by performing fuzzy processing on the fourth video frame, the fourth video frame represents a collected original video frame, the third video frame represents a compressed video frame obtained by compressing the original video frame, and during training, the third video frame is input into the first enhancement model, and the second loss function is calculated according to an output result and the fourth video frame corresponding to the third video frame.

Manner B), the fourth video frame is input into the first enhancement model if the video quality of the fourth video frame contained in the first video frame pair is lower than that of the third video frame, and the second loss function is determined according to an output result and the third video frame; and the model parameters of the first enhancement model are trained according to the second loss function, it is determined that training is completed when the value of the second loss function meets the preset condition or the number of iterations meets a threshold, and the trained enhancement model is obtained.

In this manner, the fourth video frame is obtained by performing fuzzy processing on the third video frame, the third video frame represents a collected original video frame, the fourth video frame represents a compressed video frame obtained by compressing the original video frame, and during training, the fourth video frame is input to the first enhancement model, and the second loss function is calculated according to an output result and the third video frame corresponding to the fourth video frame.

The first loss function and the second loss function in the present embodiment may be loss functions of the same type, or loss functions of different types, which are not limited too much in the present embodiment. The first loss function/second loss function in the present embodiment includes but is not limited to a mean squared error (MSE) loss function, a cross entropy loss function, an L1 loss function, a structural similarity index (SSIM) loss function, an adversarial loss function, a K-L loss function, an exposure loss function, a spatial consistency loss function, a color balance loss function, etc., and the present embodiment does not impose too many limitations on the selection of the loss functions.

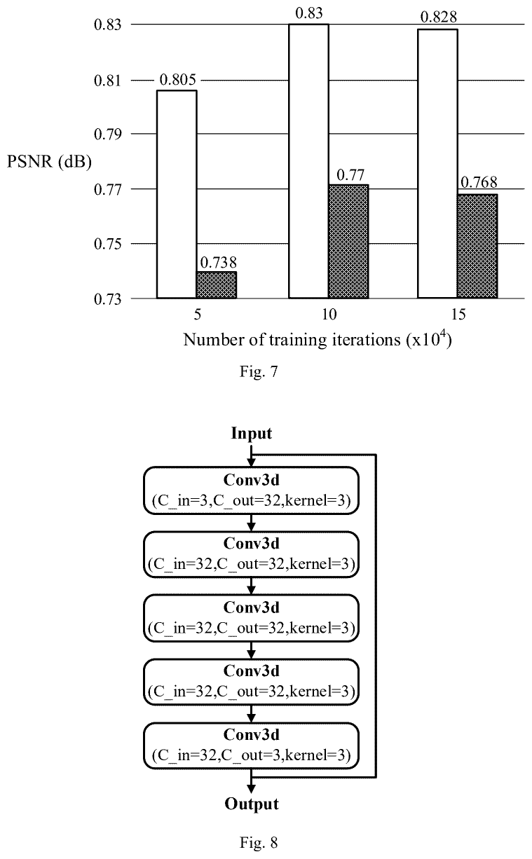

As shown in FIG. 7, the present embodiment further provides a schematic diagram of model effect comparison, wherein abscissas represent a number of iterations, and ordinates represent a peak signal to noise ratio (PSNR). On the premise that network structures training sets of the enhancement model are the same, experiments are carried out on whether to utilize the video quality enhancement method in the present disclosure. White boxes are experiment results of utilizing the video quality enhancement method in the present disclosure, and black boxes are experiment results of not utilizing the video quality enhancement method in the present disclosure. It can be obviously seen that the video quality enhancement method in the present disclosure may remarkably improve the enhancement effect on the premise of almost not increasing a training cost.

It should be noted that, the provided video quality enhancement method may be applied to various compressed video quality enhancement models. As shown in FIG. 8, the present embodiment provides a schematic structural diagram of an enhancement model. The enhancement model includes 5 layers of three-dimensional convolutional neural networks, with each layer of convolutional neural network being Conv3d (input dimension C_in=3, output dimension C_out=32, and convolutional kernel kernel=3). During implementation, an input of the enhancement model is successive compressed video frames, for example, five successive compressed video frames Finput (a dimension being 3×H×W, wherein His a height of each video frame, and W is a width of each video frame) are input, and feature pre-extraction is performed on the input five successive compressed video frames Finput through one layer of three-dimensional convolutional neural network Conv3d to obtain a pre-extracted feature F with a dimension of B×C×T×H×W (wherein B is a batching size, C is a number of processing channels, and T is a frame number of the input compressed video frames, which is 5 here specifically); and the pre-extracted feature F is input into four layers of three-dimensional convolutional neural networks Conv3d in sequence to fully fuse temporal-spatial features, and a feature F1 with an Output dimension of B×3×H×W is output. Dimensionality reduction is performed finally through one three-dimensional convolutional neural network layer, and a final output Foutput with a dimension of B×3×H×W is obtained by adding the input compressed video frames Finput. When the enhancement model is specifically trained, it needs to be trained for 10 thousand times at a pre-training stage and for 40 thousand times at a fine-adjustment stage, 50 thousand times in total. Loss functions at the pre-training stage and the fine-adjustment stage are both L1 loss functions (L1 loss).

The video quality enhancement method provided by the present embodiment can be used for improving the quality of compressed videos; and by randomly blending a large proportion of original video frames (high-quality video frames) to corresponding compressed video frames (low-quality video frames), the enhancement model is guided to correctly rearrange pixels in the compressed videos according to a pixel arrangement rule in original videos. By learning the correct arrangement of the pixels in the original videos, the enhancement model is guided to rearrange pixels on the temporal-spatial dimension in the compressed videos. It is not necessary to additionally design a teacher model and a distillation loss function, and the recovery ability of the enhancement model for compressed video frames is remarkably improved on the premise of almost not increasing the training cost.

Based on the same inventive concept, an embodiment of the present disclosure further provides a model training method. Since the training process of this method is similar to the training process for the enhancement model in any video enhancement method discussed earlier, the specific implementation of this method can be found in the implementation of the above video enhancement method, and any repetition will be omitted.

As shown in FIG. 9, a specific implementation flow of the method is as follows.

Step 900, a blended video frame is obtained by blending a first video frame and a second video frame, wherein the first video frame and the second video frame contain the same video contents with different video qualities.

Step 901, a video frame pair is determined according to the blended video frame and a tagged video frame corresponding to the blended video frame, wherein the blended video frame and the tagged video frame contain the same video contents with different video qualities.

Step 902, an enhancement model is obtained by training a to-be-trained enhancement model by utilizing a plurality of video frame pairs.

As an optional implementation, obtaining the blended video frame by blending the first video frame and the second video frame includes: selecting part of image blocks from the first video frame and the second video frame respectively, and obtaining the blended video frame by splicing the selected image blocks; or, selecting part of feature vectors from feature information of the first video frame and the second video frame respectively, obtaining a spliced feature vector by splicing the selected feature vectors, and determining the blended video frame according to the spliced feature vector.

As an optional implementation, selecting the part of image blocks from the first video frame and the second video frame respectively, and obtaining the blended video frame by splicing the selected image blocks include: splitting the first video frame into N first image blocks, and splitting the second video frame into N second image blocks, wherein N is a positive integer; selecting M first image blocks from the N first image blocks, and selecting N−M second image blocks from the N second image blocks, wherein M is an integer greater than 0 and less than N; and obtaining the blended video frame by splicing the M first image blocks and the N−M second image blocks.

As an optional implementation, the tagged video frame is determined in the following way: determining the tagged video frame corresponding to the blended video frame contained in the video frame pair according to the first video frame in a case that the video quality of the second video frame is lower than the video quality of the first video frame; or determining the tagged video frame corresponding to the blended video frame contained in the video frame pair according to the second video frame in a case that the video quality of the first video frame is lower than the video quality of the second video frame.

As an optional implementation, obtaining the enhancement model by training the to-be-trained enhancement model by utilizing the plurality of video frame pairs includes: obtaining a first enhancement model by training the to-be-trained enhancement model by utilizing the plurality of video frame pairs; and obtaining the enhancement model by continuing to train the first enhancement model by utilizing a plurality of first video frame pairs, wherein each first video frame pair includes a third video frame and a fourth video frame, and the third video frame and the fourth video frame contain the same video contents with different video qualities.

As an optional implementation, obtaining the first enhancement model by training the to-be-trained enhancement model includes: inputting the blended video frame into the to-be-trained enhancement model, and determining a first loss function according to an output result and the tagged video frame corresponding to the blended video frame; and training model parameters of the to-be-trained enhancement model according to the first loss function, determining that training is completed in response to that a value of the first loss function meets a preset condition, and obtaining the first enhancement model.

As an optional implementation, obtaining the enhancement model by continuing to train the first enhancement model by utilizing the plurality of first video frame pairs includes: inputting the third video frame into the first enhancement model in a case that the video quality of the third video frame contained in the first video frame pair is lower than the video quality of the fourth video frame, and determining a second loss function according to an output result and the fourth video frame; and training model parameters of the first enhancement model according to the second loss function, determining that training is completed in response to that a value of the second loss function meets a preset condition, and obtaining the enhancement model; or, inputting the fourth video frame into the first enhancement model in a case that the video quality of the fourth video frame contained in the first video frame pair is lower than the video quality of the third video frame, and determining the second loss function according to an output result and the third video frame; and training the model parameters of the first enhancement model according to the second loss function, determining that training is completed in response to that a value of the second loss function meets a preset condition, and obtaining the enhancement model.

Based on the same inventive concept, an embodiment of the present disclosure further provides a display device. Since the display device is a display device in the video enhancement method in the embodiment of the present disclosure and the principle of solving problems of the display device is similar to that of the video enhancement method, implementation of the display device may refer to implementation of the video enhancement method, and repetitions are omitted.

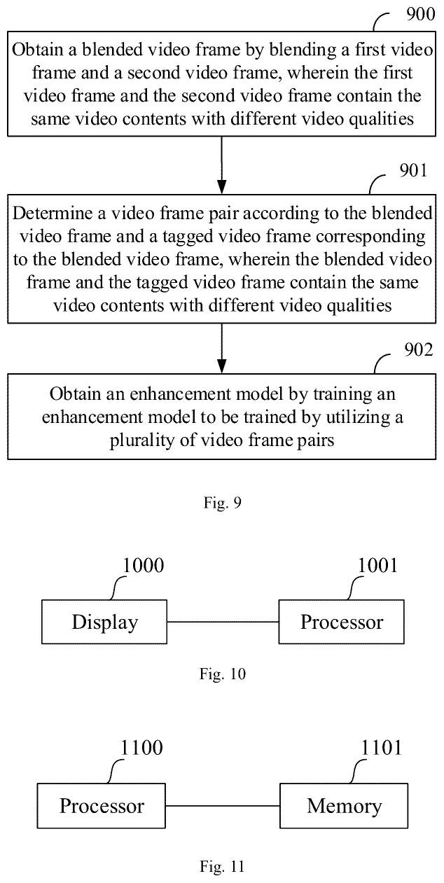

As shown in FIG. 10, the display device includes a display 1000 and a processor 1001, the display 1000 is configured to display contents, and the processor 1001 is configured to execute the following steps of: obtaining a target video frame to be processed; and inputting the target video frame into an enhancement model for performing quality enhancement, and outputting an enhanced video frame corresponding to the target video frame, wherein the enhancement model is obtained by training a plurality of video frame pairs, each video frame pair includes a blended video frame and a tagged video frame, and the blended video frame and the tagged video frame contain the same video contents with different video qualities; and each blended video frame is obtained by blending a first video frame and a second video frame, and the first video frame and the second video frame contain the same video contents with different video qualities.

As an optional implementation, the processor 1001 is specifically configured to determine the blended video frame in the following way: selecting part of image blocks from the first video frame and the second video frame respectively, and obtaining the blended video frame by splicing the selected image blocks; or, selecting part of feature vectors from feature information of the first video frame and the second video frame respectively, obtaining a spliced feature vector by splicing the selected feature vectors, and determining the blended video frame according to the spliced feature vector.

As an optional implementation, the processor 1001 is specifically configured to execute: splitting the first video frame into N first image blocks, and splitting the second video frame into N second image blocks, wherein Nis a positive integer; selecting M first image blocks from the N first image blocks, and selecting N−M second image blocks from the N second image blocks, wherein M is an integer greater than 0 and less than N; and obtaining the blended video frame by splicing the M first image blocks and the N−M second image blocks.

As an optional implementation, a size of each of the first image blocks or the second image blocks is determined according to first encoding in a case that the second video frame is obtained by performing first encoding on the first video frame; or a size of each of the first image blocks or the second image blocks is determined according to second encoding in a case that the first video frame is obtained by performing second encoding on the second video frame.

As an optional implementation, the processor 1001 is specifically configured to execute: obtaining the blended video frame by splicing the M first image blocks and the N−M second image blocks according to positions of the first image blocks and the second image blocks in respective video frames, wherein the positions of the first image blocks and the second image blocks in respective video frames are different.

As an optional implementation, the processor 1001 is specifically configured to execute: extracting first feature information of the first video frame and second feature information of the second video frame; splitting the first feature information into K first feature vectors, and splitting the second feature information into K second feature vectors, wherein K is a positive integer; obtaining feature information of the blended video frame by splicing P first feature vectors and K−P second feature vectors, wherein P is an integer greater than 0 and less than K; and determining the blended video frame according to the feature information of the blended video frame.

As an optional implementation, the processor 1001 is specifically configured to determine the tagged video frame in the following way: determining the tagged video frame corresponding to the blended video frame contained in the video frame pair according to the first video frame in a case that the video quality of the second video frame is lower than the video quality of the first video frame; or determining the tagged video frame corresponding to the blended video frame contained in the video frame pair according to the second video frame in a case that the video quality of the first video frame is lower than the video quality of the second video frame.

As an optional implementation, the processor 1001 is specifically configured to determine the enhancement model in the following way: obtaining a first enhancement model by training a to-be-trained enhancement model by utilizing the plurality of video frame pairs; and obtaining the enhancement model by continuing to train the first enhancement model by utilizing a plurality of first video frame pairs, wherein each first video frame pair includes a third video frame and a fourth video frame, and the third video frame and the fourth video frame contain the same video contents with different video qualities.

As an optional implementation, the processor 1001 is specifically configured to execute: inputting the blended video frame into the to-be-trained enhancement model, and determining a first loss function according to an output result and the tagged video frame corresponding to the blended video frame; and training model parameters of the to-be-trained enhancement model according to the first loss function, determining that training is completed in response to that a value of the first loss function meets a preset condition, and obtaining the first enhancement model.

As an optional implementation, the processor 1001 is specifically configured to execute: inputting the third video frame into the first enhancement model in a case that the video quality of the third video frame contained in the first video frame pair is lower than the video quality of the fourth video frame, and determining a second loss function according to an output result and the fourth video frame; and training model parameters of the first enhancement model according to the second loss function, determining that training is completed in response to that a value of the second loss function meets a preset condition, and obtaining the enhancement model; or, inputting the fourth video frame into the first enhancement model in a case that the video quality of the fourth video frame contained in the first video frame pair is lower than the video quality of the third video frame, and determining the second loss function according to an output result and the third video frame; and training the model parameters of the first enhancement model according to the second loss function, determining that training is completed in response to that the value of the second loss function meets the preset condition, and obtaining the enhancement model.

As an optional implementation, the fourth video frame is obtained by performing fuzzy processing on the third video frame, and the video quality of the fourth video frame is lower than the video quality of the third video frame; or, the third video frame is obtained by performing fuzzy processing on the fourth video frame, and the video quality of the third video frame is lower than the video quality of the fourth video frame.

As an optional implementation, the second video frame is obtained by performing fuzzy processing on the first video frame, and the video quality of the second video frame is lower than the video quality of the first video frame; or, the first video frame is obtained by performing fuzzy processing on the second video frame, and the video quality of the first video frame is lower than the video quality of the second video frame.

As an optional implementation, the plurality of video frame pairs have a time sequence on a temporal dimension.

Based on the same inventive concept, an embodiment of the present disclosure further provides an electronic device. Since the electronic device is an electronic device in the video enhancement method in the embodiment of the present disclosure and the principle of solving problems of the electronic device is similar to that of the video enhancement method, implementation of the electronic device may refer to implementation of the video enhancement method, and repetitions are omitted.

As shown in FIG. 11, the electronic device includes: a processor 1100 and a memory 1101, wherein the memory 1101 is configured to store a program executable by the processor, and the processor 1100 is configured to read the program in the memory 1101 and execute the following steps of: obtaining a target video frame to be processed; and inputting the target video frame into an enhancement model for performing quality enhancement, and outputting an enhanced video frame corresponding to the target video frame, wherein the enhancement model is obtained by training a plurality of video frame pairs, each video frame pair includes a blended video frame and a tagged video frame, and the blended video frame and the tagged video frame contain the same video contents with different video qualities; and each blended video frame is obtained by blending a first video frame and a second video frame, and the first video frame and the second video frame contain the same video contents with different video qualities.

As an optional implementation, the processor 1100 is specifically configured to determine the blended video frame in the following way: selecting part of image blocks from the first video frame and the second video frame respectively, and obtaining the blended video frame by splicing the selected image blocks; or, selecting part of feature vectors from feature information of the first video frame and the second video frame respectively, obtaining a spliced feature vector by splicing the selected feature vectors, and determining the blended video frame according to the spliced feature vector.

As an optional implementation, the processor 1100 is specifically configured to execute: splitting the first video frame into N first image blocks, and splitting the second video frame into N second image blocks, wherein N is a positive integer; selecting M first image blocks from the N first image blocks, and selecting N−M second image blocks from the N second image blocks, wherein M is an integer greater than 0 and less than N; and obtaining the blended video frame by splicing the M first image blocks and the N−M second image blocks.

As an optional implementation, a size of each of the first image blocks or the second image blocks is determined according to first encoding in a case that the second video frame is obtained by performing first encoding on the first video frame; or a size of each of the first image blocks or the second image blocks is determined according to second encoding in a case that the first video frame is obtained by performing second encoding on the second video frame.

As an optional implementation, the processor 1100 is specifically configured to execute: obtaining the blended video frame by splicing the M first image blocks and the N−M second image blocks according to positions of the first image blocks and the second image blocks in respective video frames, wherein the positions of the first image blocks and the second image blocks in respective video frames are different.

As an optional implementation, the processor 1100 is specifically configured to execute: extracting first feature information of the first video frame and second feature information of the second video frame; splitting the first feature information into K first feature vectors, and splitting the second feature information into K second feature vectors, wherein K is a positive integer; obtaining feature information of the blended video frame by splicing P first feature vectors and K−P second feature vectors, wherein P is an integer greater than 0 and less than K; and determining the blended video frame according to the feature information of the blended video frame.

As an optional implementation, the processor 1100 is specifically configured to determine the tagged video frame in the following way: determining the tagged video frame corresponding to the blended video frame contained in the video frame pair according to the first video frame in a case that the video quality of the second video frame is lower than the video quality of the first video frame; or determining the tagged video frame corresponding to the blended video frame contained in the video frame pair according to the second video frame in a case that the video quality of the first video frame is lower than the video quality of the second video frame.

As an optional implementation, the processor 1100 is specifically configured to determine the enhancement model in the following way: obtaining a first enhancement model by training a to-be-trained enhancement model by utilizing the plurality of video frame pairs; and obtaining the enhancement model by continuing to train the first enhancement model by utilizing a plurality of first video frame pairs, wherein each first video frame pair includes a third video frame and a fourth video frame, and the third video frame and the fourth video frame contain the same video contents with different video qualities.

As an optional implementation, the processor 1100 is specifically configured to execute: inputting the blended video frame into the to-be-trained enhancement model, and determining a first loss function according to an output result and the tagged video frame corresponding to the blended video frame; and training model parameters of the to-be-trained enhancement model according to the first loss function, determining that training is completed in response to that a value of the first loss function meets a preset condition, and obtaining the first enhancement model.

As an optional implementation, the processor 1100 is specifically configured to execute: inputting the third video frame into the first enhancement model in a case that the video quality of the third video frame contained in the first video frame pair is lower than the video quality of the fourth video frame, and determining a second loss function according to an output result and the fourth video frame; and training model parameters of the first enhancement model according to the second loss function, determining that training is completed in response to that a value of the second loss function meets a preset condition, and obtaining the enhancement model; or, inputting the fourth video frame into the first enhancement model in a case that the video quality of the fourth video frame contained in the first video frame pair is lower than the video quality of the third video frame, and determining the second loss function according to an output result and the third video frame; and training the model parameters of the first enhancement model according to the second loss function, determining that training is completed in response to that the value of the second loss function meets the preset condition, and obtaining the enhancement model.

As an optional implementation, the fourth video frame is obtained by performing fuzzy processing on the third video frame, and the video quality of the fourth video frame is lower than the video quality of the third video frame; or, the third video frame is obtained by performing fuzzy processing on the fourth video frame, and the video quality of the third video frame is lower than the video quality of the fourth video frame.

As an optional implementation, the second video frame is obtained by performing fuzzy processing on the first video frame, and the video quality of the second video frame is lower than the video quality of the first video frame; or, the first video frame is obtained by performing fuzzy processing on the second video frame, and the video quality of the first video frame is lower than the video quality of the second video frame.

As an optional implementation, the plurality of video frame pairs have a time sequence on a temporal dimension.

Based on the same inventive concept, an embodiment of the present disclosure further provides another electronic device. Since the electronic device is an electronic device in the video enhancement method in the embodiment of the present disclosure and the principle of solving problems of the electronic device is similar to that of the video enhancement method, implementation of the electronic device may refer to implementation of the video enhancement method, and repetitions are omitted.

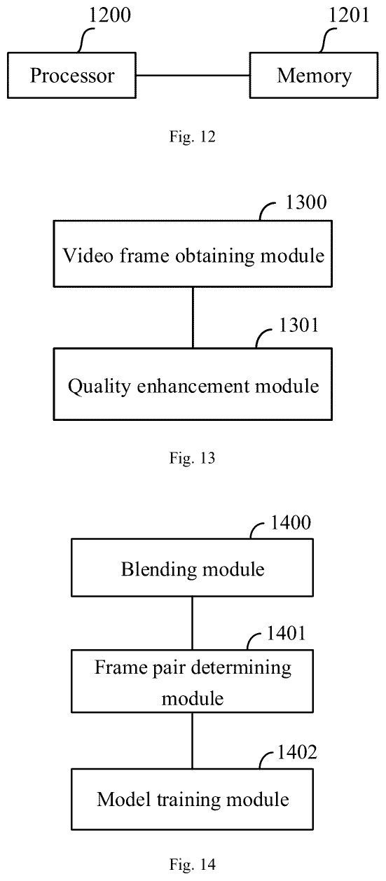

As shown in FIG. 12, the electronic device includes: a processor 1200 and a memory 1201, the memory 1201 is configured to store a program executable by the processor, and the processor 1200 is configured to read the program in the memory 1201 and execute the following steps of: obtaining a blended video frame by blending a first video frame and a second video frame, wherein the first video frame and the second video frame contain the same video contents with different video qualities; determining a video frame pair according to the blended video frame and a tagged video frame corresponding to the blended video frame, wherein the blended video frame and the tagged video frame contain the same video contents with different video qualities; and obtaining an enhancement model by training a to-be-trained enhancement model by utilizing a plurality of video frame pairs.

As an optional implementation, the processor 1200 is specifically configured to execute: selecting part of image blocks from the first video frame and the second video frame respectively, and obtaining the blended video frame by splicing the selected image blocks; or, selecting part of feature vectors from feature information of the first video frame and the second video frame respectively, obtaining a spliced feature vector by splicing the selected feature vectors, and determining the blended video frame according to the spliced feature vector.

As an optional implementation, the processor 1200 is specifically configured to execute: splitting the first video frame into N first image blocks, and splitting the second video frame into N second image blocks, wherein N is a positive integer; selecting M first image blocks from the N first image blocks, and selecting N−M second image blocks from the N second image blocks, wherein M is an integer greater than 0 and less than N; and obtaining the blended video frame by splicing the M first image blocks and the N−M second image blocks.

As an optional implementation, the processor 1200 is specifically configured to determine the tagged video frame in the following way: determining the tagged video frame corresponding to the blended video frame contained in the video frame pair according to the first video frame in a case that the video quality of the second video frame is lower than the video quality of the first video frame; or determining the tagged video frame corresponding to the blended video frame contained in the video frame pair according to the second video frame in a case that the video quality of the first video frame is lower than the video quality of the second video frame.

As an optional implementation, the processor 1200 is specifically configured to execute: obtaining the first enhancement model by training the to-be-trained enhancement model by utilizing the plurality of video frame pairs; and obtaining the enhancement model by continuing to train the first enhancement model by utilizing a plurality of first video frame pairs, wherein each first video frame pair includes a third video frame and a fourth video frame, and the third video frame and the fourth video frame contain the same video contents with different video qualities.

As an optional implementation, the processor 1200 is specifically configured to execute: inputting the blended video frame into the to-be-trained enhancement model, and determining a first loss function according to an output result and the tagged video frame corresponding to the blended video frame; and training model parameters of the to-be-trained enhancement model according to the first loss function, determining that training is completed in response to that a value of the first loss function meets a preset condition, and obtaining the first enhancement model.

As an optional implementation, the processor 1200 is specifically configured to execute: inputting the third video frame into the first enhancement model in a case that the video quality of the third video frame contained in the first video frame pair is lower than the video quality of the fourth video frame, and determining a second loss function according to an output result and the fourth video frame; and training model parameters of the first enhancement model according to the second loss function, determining that training is completed in response to that a value of the second loss function meets a preset condition, and obtaining the enhancement model; or, inputting the fourth video frame into the first enhancement model in a case that the video quality of the fourth video frame contained in the first video frame pair is lower than the video quality of the third video frame, and determining the second loss function according to an output result and the third video frame; and training the model parameters of the first enhancement model according to the second loss function, determining that training is completed in response to that the value of the second loss function meets the preset condition, and obtaining the enhancement model.

Based on the same inventive concept, an embodiment of the present disclosure further provides a video enhancement apparatus. Since the apparatus is an apparatus in the video enhancement method in the embodiment of the present disclosure and the principle of solving problems of the apparatus is similar to that of the video enhancement method, implementation of the apparatus may refer to implementation of the video enhancement method, and repetitions are omitted.

As shown in FIG. 13, the apparatus includes: a video frame obtaining module 1300, configured to obtain a target video frame to be processed; and a quality enhancement module 1301, configured to input the target video frame into an enhancement model for performing quality enhancement, and output an enhanced video frame corresponding to the target video frame, wherein the enhancement model is obtained by training a plurality of video frame pairs, each video frame pair includes a blended video frame and a tagged video frame, and the blended video frame and the tagged video frame contain the same video contents with different video qualities; and each blended video frame is obtained by blending a first video frame and a second video frame, and the first video frame and the second video frame contain the same video contents with different video qualities.

As an optional implementation, the quality enhancement module 1301 is specifically configured to determine the blended video frame in the following way: selecting part of image blocks from the first video frame and the second video frame respectively, and obtaining the blended video frame by splicing the selected image blocks; or, selecting part of feature vectors from feature information of the first video frame and the second video frame respectively, obtaining a spliced feature vector by splicing the selected feature vectors, and determining the blended video frame according to the spliced feature vector.

As an optional implementation, the quality enhancement module 1301 is specifically configured to: split the first video frame into N first image blocks, and split the second video frame into N second image blocks, wherein N is a positive integer; select M first image blocks from the N first image blocks, and select N−M second image blocks from the N second image blocks, wherein M is an integer greater than 0 and less than N; and obtain the blended video frame by splicing the M first image blocks and the N−M second image blocks.

As an optional implementation, a size of each of the first image blocks or the second image blocks is determined according to first encoding in a case that the second video frame is obtained by performing first encoding on the first video frame; or a size of each of the first image blocks or the second image blocks is determined according to second encoding in a case that the first video frame is obtained by performing second encoding on the second video frame.

As an optional implementation, the quality enhancement module 1301 is specifically configured to: obtain the blended video frame by splicing the M first image blocks and the N−M second image blocks according to positions of the first image blocks and the second image blocks in respective video frames, wherein the positions of the first image blocks and the second image blocks in respective video frames are different.

As an optional implementation, the quality enhancement module 1301 is specifically configured to: extract first feature information of the first video frame and second feature information of the second video frame; split the first feature information into K first feature vectors, and split the second feature information into K second feature vectors, wherein K is a positive integer; obtain feature information of the blended video frame by splicing P first feature vectors and K−P second feature vectors, wherein P is an integer greater than 0 and less than K; and determine the blended video frame according to the feature information of the blended video frame.

As an optional implementation, the quality enhancement module 1301 is specifically configured to determine the tagged video frame in the following way: determining the tagged video frame corresponding to the blended video frame contained in the video frame pair according to the first video frame in a case that the video quality of the second video frame is lower than the video quality of the first video frame; or determining the tagged video frame corresponding to the blended video frame contained in the video frame pair according to the second video frame in a case that the video quality of the first video frame is lower than the video quality of the second video frame.

As an optional implementation, the quality enhancement module 1301 is specifically configured to determine the enhancement model in the following way: obtaining a first enhancement model by training a to-be-trained enhancement model by utilizing the plurality of video frame pairs; and obtaining the enhancement model by continuing to train the first enhancement model by utilizing a plurality of first video frame pairs, wherein each first video frame pair includes a third video frame and a fourth video frame, and the third video frame and the fourth video frame contain the same video contents with different video qualities.

As an optional implementation, the quality enhancement module 1301 is specifically configured to: input the blended video frame into the to-be-trained enhancement model, and determine a first loss function according to an output result and the tagged video frame corresponding to the blended video frame; and train model parameters of the to-be-trained enhancement model according to the first loss function, determine that training is completed in response to that a value of the first loss function meets a preset condition, and obtain the first enhancement model.

As an optional implementation, the quality enhancement module 1301 is specifically configured to: input the third video frame into the first enhancement model in a case that the video quality of the third video frame contained in the first video frame pair is lower than the video quality of the fourth video frame, and determine a second loss function according to an output result and the fourth video frame; and train model parameters of the first enhancement model according to the second loss function, determine that training is completed in response to that a value of the second loss function meets a preset condition, and obtain the enhancement model; or, input the fourth video frame into the first enhancement model in a case that the video quality of the fourth video frame contained in the first video frame pair is lower than the video quality of the third video frame, and determine the second loss function according to an output result and the third video frame; and train the model parameters of the first enhancement model according to the second loss function, determine that training is completed in response to that the value of the second loss function meets the preset condition, and obtain the enhancement model.

As an optional implementation, the fourth video frame is obtained by performing fuzzy processing on the third video frame, and the video quality of the fourth video frame is lower than the video quality of the third video frame; or, the third video frame is obtained by performing fuzzy processing on the fourth video frame, and the video quality of the third video frame is lower than the video quality of the fourth video frame.

As an optional implementation, the second video frame is obtained by performing fuzzy processing on the first video frame, and the video quality of the second video frame is lower than the video quality of the first video frame; or, the first video frame is obtained by performing fuzzy processing on the second video frame, and the video quality of the first video frame is lower than the video quality of the second video frame.

As an optional implementation, the plurality of video frame pairs have a time sequence on a temporal dimension.

Based on the same inventive concept, an embodiment of the present disclosure further provides a model training apparatus. Since the apparatus is an apparatus in the model training method in the embodiment of the present disclosure and the principle of solving problems of the apparatus is similar to that of the model training method, implementation of the apparatus may refer to implementation of the model training method, and repetitions are omitted.

As shown in FIG. 14, the apparatus includes: a blending module 1400, configured to obtain a blended video frame by blending a first video frame and a second video frame, wherein the first video frame and the second video frame contain the same video contents with different video qualities; a frame pair determining module 1401, configured to determine a video frame pair according to the blended video frame and a tagged video frame corresponding to the blended video frame, wherein the blended video frame and the tagged video frame contain the same video contents with different video qualities; and a model training module 1402, configured to obtain an enhancement model by training a to-be-trained enhancement model by utilizing a plurality of video frame pairs.

As an optional implementation, the blending module 1400 is specifically configured to: select part of image blocks from the first video frame and the second video frame respectively, and obtain the blended video frame by splicing the selected image blocks; or, select part of feature vectors from feature information of the first video frame and the second video frame respectively, obtain a spliced feature vector by splicing the selected feature vectors, and determine the blended video frame according to the spliced feature vector.

As an optional implementation, the blending module 1400 is specifically configured to: split the first video frame into N first image blocks, and split the second video frame into N second image blocks, wherein N is a positive integer; select M first image blocks from the N first image blocks, and select N−M second image blocks from the N second image blocks, wherein M is an integer greater than 0 and less than N; and obtain the blended video frame by splicing the M first image blocks and the N−M second image blocks.

As an optional implementation, the frame pair determining module 1401 is specifically configured to determine the tagged video frame in the following way: determining the tagged video frame corresponding to the blended video frame contained in the video frame pair according to the first video frame in a case that the video quality of the second video frame is lower than the video quality of the first video frame; or determining the tagged video frame corresponding to the blended video frame contained in the video frame pair according to the second video frame in a case that the video quality of the first video frame is lower than the video quality of the second video frame.

As an optional implementation, the model training module 1402 is specifically configured to: obtain a first enhancement model by training a to-be-trained enhancement model by utilizing the plurality of video frame pairs; and obtain the enhancement model by continuing to train the first enhancement model by utilizing a plurality of first video frame pairs, wherein each first video frame pair includes a third video frame and a fourth video frame, and the third video frame and the fourth video frame contain the same video contents with different video qualities.

As an optional implementation, the model training module 1402 is specifically configured to: input the blended video frame into the to-be-trained enhancement model, and determine a first loss function according to an output result and the tagged video frame corresponding to the blended video frame; and train model parameters of the to-be-trained enhancement model according to the first loss function, determine that training is completed in response to that a value of the first loss function meets a preset condition, and obtain the first enhancement model.

As an optional implementation, the model training module 1402 is specifically configured to: input the third video frame into the first enhancement model in a case that the video quality of the third video frame contained in the first video frame pair is lower than the video quality of the fourth video frame, and determine a second loss function according to an output result and the fourth video frame; and train model parameters of the first enhancement model according to the second loss function, determine that training is completed in response to that a value of the second loss function meets a preset condition, and obtain the enhancement model; or, input the fourth video frame into the first enhancement model in a case that the video quality of the fourth video frame contained in the first video frame pair is lower than the video quality of the third video frame, and determine the second loss function according to an output result and the third video frame; and train the model parameters of the first enhancement model according to the second loss function, determine that training is completed in response to that the value of the second loss function meets the preset condition, and obtain the enhancement model.

Based on the same inventive concept, an embodiment of the present disclosure provides a computer storage medium. The computer storage medium includes: a computer program code, and the computer program code, when running on a computer, causes the computer to execute any one of the video enhancement method or the model training method discussed above. Since the principle of solving problems of the above computer storage medium is similar to that of the video enhancement method or the model training method, implementation of the above computer storage medium may refer to implementation of the methods, and repetitions are omitted.

In a specific implementation process, the computer storage medium may include: a universal serial bus (USB) flash drive, a mobile hard disk, a read-only memory (ROM), a random access memory (RAM), a magnetic disk or an optical disk and other storage media that can store program codes.

Based on the same inventive concept, an embodiment of the present disclosure further provides a computer program product. The computer program product includes: a computer program code, and the computer program code, when running on a computer, causes the computer to execute any one of the video enhancement method or the model training method discussed above. Since the principle of solving problems of the above computer program product is similar to that of the video enhancement method or the model training method, implementation of the above computer program product may refer to implementation of the methods, and repetitions are omitted.

The computer program product may adopt one or any combination of more readable media. The readable media may be readable signal media or readable storage media. The readable storage media may be, for example, but are not limited to, an electrical, magnetic, optical, electromagnetic, infrared, or semiconductor system, apparatus, or device, or any combination of the above. More specific examples (non exhaustive list) of the readable storage media include: electrical connection with one or more wires, a portable disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device or any suitable combination of the above.

Those skilled in the art will appreciate that the embodiments of the present disclosure may be provided as methods, systems, or computer program products. Therefore, the present disclosure may take the form of a full hardware embodiment, a full software embodiment, or an embodiment combining software and hardware. Besides, the present disclosure may adopt the form of a computer program product implemented on one or more computer available storage media (including, but not limited to, a disk memory, an optical memory and the like) containing computer available program codes.

The present disclosure is described with reference to the flow diagrams and/or block diagrams of the method, device (system), and computer program product according to the embodiments of the present disclosure. It should be understood that each flow and/or block in the flow diagram and/or block diagram and the combination of flows and/or blocks in the flow diagram and/or block diagram can be implemented by computer program instructions. These computer program instructions can be provided to processors of a general-purpose computer, a special-purpose computer, an embedded processor or other programmable data processing devices to generate a machine, so that instructions executed by processors of a computer or other programmable data processing devices generate a device for implementing the functions specified in one or more flows of the flow diagram and/or one or more blocks of the block diagram.

These computer program instructions can also be stored in a computer-readable memory capable of guiding a computer or other programmable data processing devices to work in a specific manner, so that instructions stored in the computer-readable memory generate a manufacturing product including an instruction device, and the instruction device implements the functions specified in one or more flows of the flow diagram and/or one or more blocks of the block diagram.

These computer program instructions can also be loaded on a computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow diagram and/or one or more blocks of the block diagram.

Apparently, those skilled in the art can make various modifications and variations to the present disclosure without departing from the spirit and scope of the present disclosure. In this way, if these modifications and variations of the present disclosure fall within the scope of the claims of the present disclosure and equivalent technologies thereof, the present disclosure is also intended to include these modifications and variations.

1.-23. (canceled)

24. A video quality enhancement method, comprising:
obtaining a target video frame to be processed; and
inputting the target video frame into an enhancement model for performing quality enhancement, and outputting an enhanced video frame corresponding to the target video frame, wherein the enhancement model is obtained by training a plurality of video frame pairs, each video frame pair comprises a blended video frame and a tagged video frame, and the blended video frame and the tagged video frame contain the same video contents with different video qualities; and the blended video frame is obtained by blending a first video frame and a second video frame, the first video frame and the second video frame contain the same video contents with different video qualities, and the first video frame and the second video frame are video frames used by the enhancement model in a training process.

25. The method according to claim 24, wherein the blended video frame is determined in the following way:
selecting part of image blocks from the first video frame and the second video frame respectively, and obtaining the blended video frame by splicing the selected image blocks; or,
selecting part of feature vectors from feature information of the first video frame and the second video frame respectively, obtaining a spliced feature vector by splicing the selected feature vectors, and determining the blended video frame according to the spliced feature vector.

26. The method according to claim 25, wherein the selecting part of image blocks from the first video frame and the second video frame respectively, and obtaining the blended video frame by splicing the selected image blocks comprises:
splitting the first video frame into N first image blocks, and splitting the second video frame into N second image blocks, wherein N is a positive integer;
selecting M first image blocks from the N first image blocks, and selecting N−M second image blocks from the N second image blocks, wherein M is an integer greater than 0 and less than N; and
obtaining the blended video frame by splicing the M first image blocks and the N−M second image blocks.

27. The method according to claim 26, wherein:
a size of each of the first image blocks or the second image blocks is determined according to first encoding in a case that the second video frame is obtained by performing first encoding on the first video frame; or
a size of each of the first image blocks or the second image blocks is determined according to second encoding in a case that the first video frame is obtained by performing second encoding on the second video frame.

28. The method according to claim 26, wherein the obtaining the blended video frame by splicing the M first image blocks and the N−M second image blocks comprises:
obtaining the blended video frame by splicing the M first image blocks and the N−M second image blocks according to positions of the first image blocks and the second image blocks in respective video frames, wherein the positions of the first image blocks and the second image blocks in respective video frames are different.

29. The method according to claim 25, wherein the selecting part of feature vectors from feature information of the first video frame and the second video frame respectively, obtaining a spliced feature vector by splicing the selected feature vectors, and determining the blended video frame according to the spliced feature vector comprises:
extracting first feature information of the first video frame and second feature information of the second video frame;
splitting the first feature information into K first feature vectors, and splitting the second feature information into K second feature vectors, wherein K is a positive integer;
obtaining feature information of the blended video frame by splicing P first feature vectors and K−P second feature vectors, wherein P is an integer greater than 0 and less than K; and
determining the blended video frame according to the feature information of the blended video frame.

30. The method according to claim 24, wherein the tagged video frame is determined in the following way:
determining the tagged video frame corresponding to the blended video frame contained in the video frame pair according to the first video frame in a case that the video quality of the second video frame is lower than the video quality of the first video frame; or
determining the tagged video frame corresponding to the blended video frame contained in the video frame pair according to the second video frame in a case that the video quality of the first video frame is lower than the video quality of the second video frame.

31. The method according to claim 24, wherein the enhancement model is determined in the following way:
obtaining a first enhancement model by training a to-be-trained enhancement model by utilizing the plurality of video frame pairs; and
obtaining the enhancement model by continuing to train the first enhancement model by utilizing a plurality of first video frame pairs, wherein each first video frame pair comprises a third video frame and a fourth video frame, and the third video frame and the fourth video frame contain the same video contents with different video qualities.

32. The method according to claim 31, wherein the obtaining the first enhancement model by training the to-be-trained enhancement model comprises:
inputting the blended video frame into the to-be-trained enhancement model, and determining a first loss function according to an output result and the tagged video frame corresponding to the blended video frame; and
training model parameters of the to-be-trained enhancement model according to the first loss function, determining that the training is completed in response to that a value of the first loss function meets a preset condition, and obtaining the first enhancement model.

33. The method according to claim 31, wherein the obtaining the enhancement model by continuing to train the first enhancement model by utilizing the plurality of first video frame pairs comprises:
inputting the third video frame into the first enhancement model in a case that the video quality of the third video frame contained in the first video frame pair is lower than the video quality of the fourth video frame, and determining a second loss function according to an output result and the fourth video frame; and training model parameters of the first enhancement model according to the second loss function, determining that the training is completed in response to that a value of the second loss function meets a preset condition, and obtaining the enhancement model; or,
inputting the fourth video frame into the first enhancement model in a case that the video quality of the fourth video frame contained in the first video frame pair is lower than the video quality of the third video frame, and determining a second loss function according to an output result and the third video frame; and training the model parameters of the first enhancement model according to the second loss function, determining that the training is completed in response to that a value of the second loss function meets a preset condition, and obtaining the enhancement model.

34. The method according to claim 31, wherein the fourth video frame is obtained by performing fuzzy processing on the third video frame, and the video quality of the fourth video frame is lower than the video quality of the third video frame; or,
the third video frame is obtained by performing fuzzy processing on the fourth video frame, and the video quality of the third video frame is lower than the video quality of the fourth video frame.

35. The method according to claim 24, wherein the second video frame is obtained by performing fuzzy processing on the first video frame, and the video quality of the second video frame is lower than the video quality of the first video frame; or,
the first video frame is obtained by performing fuzzy processing on the second video frame, and the video quality of the first video frame is lower than the video quality of the second video frame.

36. A model training method, comprising:
obtaining a blended video frame by blending a first video frame and a second video frame, wherein the first video frame and the second video frame contain the same video contents with different video qualities;
determining a video frame pair according to the blended video frame and a tagged video frame corresponding to the blended video frame, wherein the blended video frame and the tagged video frame contain the same video contents with different video qualities; and
obtaining an enhancement model by training a to-be-trained enhancement model by utilizing a plurality of video frame pairs.

37. The method according to claim 36, wherein the obtaining the blended video frame by blending the first video frame and the second video frame comprises:
selecting part of image blocks from the first video frame and the second video frame respectively, and obtaining the blended video frame by splicing the selected image blocks; or,
selecting part of feature vectors from feature information of the first video frame and the second video frame respectively, obtaining a spliced feature vector by splicing the selected feature vectors, and determining the blended video frame according to the spliced feature vector.

38. The method according to claim 37, wherein the selecting part of image blocks from the first video frame and the second video frame respectively, and obtaining the blended video frame by splicing the selected image blocks comprises:
splitting the first video frame into N first image blocks, and splitting the second video frame into N second image blocks, wherein N is a positive integer;
selecting M first image blocks from the N first image blocks, and selecting N−M second image blocks from the N second image blocks, wherein M is an integer greater than 0 and less than N; and
obtaining the blended video frame by splicing the M first image blocks and the N−M second image blocks.

39. The method according to claim 36, wherein the tagged video frame is determined in the following way:
determining the tagged video frame corresponding to the blended video frame contained in the video frame pair according to the first video frame in a case that the video quality of the second video frame is lower than the video quality of the first video frame; or
determining the tagged video frame corresponding to the blended video frame contained in the video frame pair according to the second video frame in a case that the video quality of the first video frame is lower than the video quality of the second video frame.

40. The method according to claim 36, wherein the obtaining the enhancement model by training the to-be-trained enhancement model by utilizing the plurality of video frame pairs comprises:
obtaining a first enhancement model by training the to-be-trained enhancement model by utilizing the plurality of video frame pairs; and
obtaining the enhancement model by continuing to train the first enhancement model by utilizing a plurality of first video frame pairs, wherein each first video frame pair comprises a third video frame and a fourth video frame, and the third video frame and the fourth video frame contain the same video contents with different video qualities.

41. The method according to claim 40, wherein the obtaining the first enhancement model by training the to-be-trained enhancement model comprises:
inputting the blended video frame into the to-be-trained enhancement model, and determining a first loss function according to an output result and the tagged video frame corresponding to the blended video frame; and
training model parameters of the to-be-trained enhancement model according to the first loss function, determining that the training is completed in response to that a value of the first loss function meets a preset condition, and obtaining the first enhancement model.

42. The method according to claim 40, wherein the obtaining the enhancement model by continuing to train the first enhancement model by utilizing the plurality of first video frame pairs comprises:
inputting the third video frame into the first enhancement model in a case that the video quality of the third video frame contained in the first video frame pair is lower than the video quality of the fourth video frame, and determining a second loss function according to an output result and the fourth video frame; and training model parameters of the first enhancement model according to the second loss function, determining that the training is completed in response to that a value of the second loss function meets a preset condition, and obtaining the enhancement model; or,
inputting the fourth video frame into the first enhancement model in a case that the video quality of the fourth video frame contained in the first video frame pair is lower than the video quality of the third video frame, and determining a second loss function according to an output result and the third video frame; and training the model parameters of the first enhancement model according to the second loss function, determining that the training is completed in response to that a value of the second loss function meets a preset condition, and obtaining the enhancement model.

43. A display device, comprising a display and a processor, wherein:
the display is configured to display contents; and
the processor is configured to execute steps of the method according to claim 24.
